(19) United States
(12) Patent Application Publication
(10) Pub. No.: US 2010/0257058 A1
(43) Pub. Date: Oct. 7, 2010

(54) ADVERTISING BIDS BASED ON USER INTERACTIONS

(75) Inventors: Ron Karidi, Herzeliya (IL); Moshe Tennenholtz, Haifa (IL)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/418,627

(22) Filed: Apr. 6, 2009

(51) Int. Cl. G06Q 30/00

(52) U.S. Cl. 705/14.55; 705/27; 705/14.73

(57) ABSTRACT

Methods, systems, and computer-readable media are disclosed for processing advertising bids based on user interactions. A particular method represents available user interactions in a probabilistic interaction graph that contains user interaction probabilities. Bids for advertising opportunities are received, and an expected overall bid value for each of the received bids is calculated using the probabilistic interaction graph. The bids with the highest expected overall bid values are awarded the advertising opportunities. The bidders awarded advertising opportunities are charged a fee that may be based on actual user interactions, the expected overall bid value of their bid, and the next-highest expected overall bid value of the received bids.

### BACKGROUND

Online advertising may be priced based on different pricing models, such as cost per impression (CPM), cost per click (CPC), cost per lead (CPL), and cost per acquisition (CPA). CPM and CPC are used in a significant number of online advertising transactions.

Online content providers often include advertising opportunities alongside the online content. For example, the advertising opportunities may include different webpage areas that are dedicated to advertisements. Generally, the more desirable an advertising opportunity, the greater the competition among advertisers for that advertising opportunity. One possible way to resolve competition associated with an advertising opportunity is to use an advertising auction. Advertising auctions are typically associated with CPC pricing, although auctions may be based on the other pricing models (CPA, CPL, and CPM). With CPC pricing, advertisers bid on a price per click and do not typically bid on user interactions other than user click-throughs. Since user interactions other than user click-throughs have advertising value, a CPC-only auction may not account for a full range of advertising opportunities.

### SUMMARY

A system of processing bids for advertising opportunities based on user interactions is disclosed. Available user interactions are represented by a probabilistic interaction graph that includes nodes corresponding to the available user interactions and edges corresponding to the probability of the available user interactions. The probability of the available user interactions can be determined empirically or predictively.

Bidders may use the system to place bids for advertising opportunities, and each placed bid may include bid amounts corresponding to various available user interactions. For example, the user interactions can include not only clicks, but other user interactions, such as views, information submission, and specific requests.

To resolve competition for advertising opportunities, the probabilistic interaction graph is used to calculate an expected overall bid value from each of the submitted bids. Bids with a higher expected overall bid value are generally awarded advertising opportunities over bids with a lower expected overall bid value. Bidders awarded advertising opportunities may be charged a fee based on actual user activity, the expected overall bid value of their bid, and a next highest expected overall bid value. By including the next highest expected overall bid value in the fee calculation, the system may provide bidders with an incentive to bid their true values for the available user interactions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a system of processing advertising bids based on user interactions;

FIG. 2 is an illustration of a particular embodiment of a probabilistic interaction graph that may be used in processing advertising bids based on user interactions;

FIG. 3 is an illustration of another particular embodiment of a probabilistic interaction graph that may be used in processing advertising bids based on user interactions;

FIG. 4 is an illustration of a particular embodiment of a method of modifying an existing probabilistic interaction graph that may be used in processing advertising bids based on user interactions;

FIG. 5 is an illustration of another particular embodiment of a method of modifying an existing probabilistic interaction graph that may be used in processing advertising bids based on user interactions;

FIG. 6 is a diagram to illustrate a particular example of mapping a composite bid based on user interactions to a probabilistic interaction graph;

FIG. 7 is a flow diagram of a particular embodiment of a method of processing advertising bids based on user interactions;

FIG. 8 is a flow diagram of another particular embodiment of a method of processing advertising bids based on user interactions;

FIG. 9 is a flow diagram of a particular embodiment of a method of processing advertising bids based on user interactions at an auction system that is capable of tracking user activity at a website;

FIG. 10 is a flow diagram of a particular embodiment of a method of processing advertising bids based on user interactions for advertising opportunities at a website;

FIG. 11 is a flow diagram of another particular embodiment of a method of processing advertising bids based on user interactions for advertising opportunities at a website;

FIG. 12 is a screenshot of a particular embodiment of an interactive advertisement that may be associated with user interactions;

FIG. 13 is a screenshot of a particular embodiment of a webpage that may be associated with user interactions;

FIG. 14 is a screenshot of a particular embodiment of a bidding engine user interface that may be used to submit advertising bids based on user interactions;

FIG. 15 is a screenshot of another particular embodiment of a bidding engine user interface that may be used to submit bids based on user interactions;

FIG. 16 is a screenshot of a particular embodiment of an auction engine report that may indicate the result of evaluating bids based on user interactions; and

FIG. 17 is a block diagram of a computing environment including a computing device operable to support embodiments of computer-implemented methods, computer program products, system components, apparatus, and articles of manufacture including program logic as illustrated in FIGS. 1-16.

### DETAILED DESCRIPTION

In a particular embodiment, a method is disclosed that includes representing a plurality of available user interactions in a probabilistic interaction graph. The probabilistic interaction graph includes a plurality of nodes connected by a plurality of edges. Each node of the probabilistic interaction graph represents a particular available user interaction, and each edge of the probabilistic interaction graph represents an associated user interaction probability. The method also includes receiving a plurality of bids from a plurality of bidders for an advertising opportunity, at a computer. Each bid includes at least one bid amount corresponding to an available user interaction. The method also includes calculating an expected overall bid value from each of the plurality of bids at the computer. The method includes choosing a winning bid from the plurality of bids on the basis of a highest expected overall bid value and awarding the advertising opportunity to a winning bidder associated with the winning bid. The method also includes charging the winning bidder a fee. In a particular embodiment, the fee is based on actual user interactions, the highest expected overall bid value of the winning bid, and a second highest expected overall bid value of a second place bid.

In another particular embodiment, a system is disclosed that includes a bidding engine and an auction engine. The bidding engine can access a probabilistic interaction graph representing a plurality of available user interactions. The probabilistic interaction graph includes a plurality of nodes and a plurality of edges, where each node corresponds to an available user interaction and each edge has an associated user interaction probability. The bidding engine can also provide a user interface that allows a bidder to enter at least one bid amount corresponding to each available user interaction. The user interface allows a bidder to submit a bid, where the bid includes at least one bid amount. The auction engine can receive a plurality of bids submitted by a plurality of bidders via a bidding engine. In a particular embodiment, the auction engine receives bids, where each bid is submitted as a probabilistic interaction graph. The auction engine can calculate an expected overall bid value for each of the plurality of bids and choose a winning bid from the plurality of bids on the basis of a highest expected overall bid value.

In another particular embodiment, a computer-readable medium is disclosed. The computer-readable medium includes instructions, that when executed by a computer, cause the computer to receive bids (e.g., B bids) for a number (e.g., N) of online advertising opportunities. Each bid includes a representation of at least one available user interaction at a website in a probabilistic interaction graph, where the probabilistic interaction graph includes a plurality of nodes connected by a plurality of edges. Each bid also includes at least one bid amount corresponding to a particular node of the probabilistic interaction graph. The computer-readable medium also includes instructions, that when executed by the computer, cause the computer to rank the N online advertising opportunities, calculate an expected overall bid value from each of the B bids, and rank the B bids according to their expected overall bid value. Each of the plurality of edges in the probabilistic interaction graph may have an associated user interaction probability that may change continuously and that may be automatically calculated for a particular moment in time by the computer. The computer-readable medium includes instructions, that when executed by the computer, cause the computer to award each online advertising opportunity of the N online advertising opportunities to a correspondingly ranked bid of the B bids. In a particular embodiment, different advertisers (e.g., bidders) may submit different probabilistic interaction graphs for different online advertising opportunities. A winning bid may be determined for each particular online advertising opportunity from bids submitted for the particular online advertising opportunity.

In a particular embodiment, an advertiser may express preferences regarding the payment scheme in which the advertiser may be charged if the advertiser wins an auction. For example, the advertiser may specify how the value of a second placed bid may be applied to calculate a fee charged to the advertiser. In a particular embodiment, the advertiser provides a prioritized payment scheme, indicating what percentage of each bid amount should be used in calculating the fee. For example, if the N bid amounts (B) are ordered by probability (i.e., ordered by B*P), then the advertiser may provide a payment scheme that indicates that a constraint C₁% of B₁ should be applied first, followed by C₂% of B₂, etc. upto C_{N}% of B_{N}. In a particular embodiment, constraints that have a value greater than zero are used to calculate the fee.

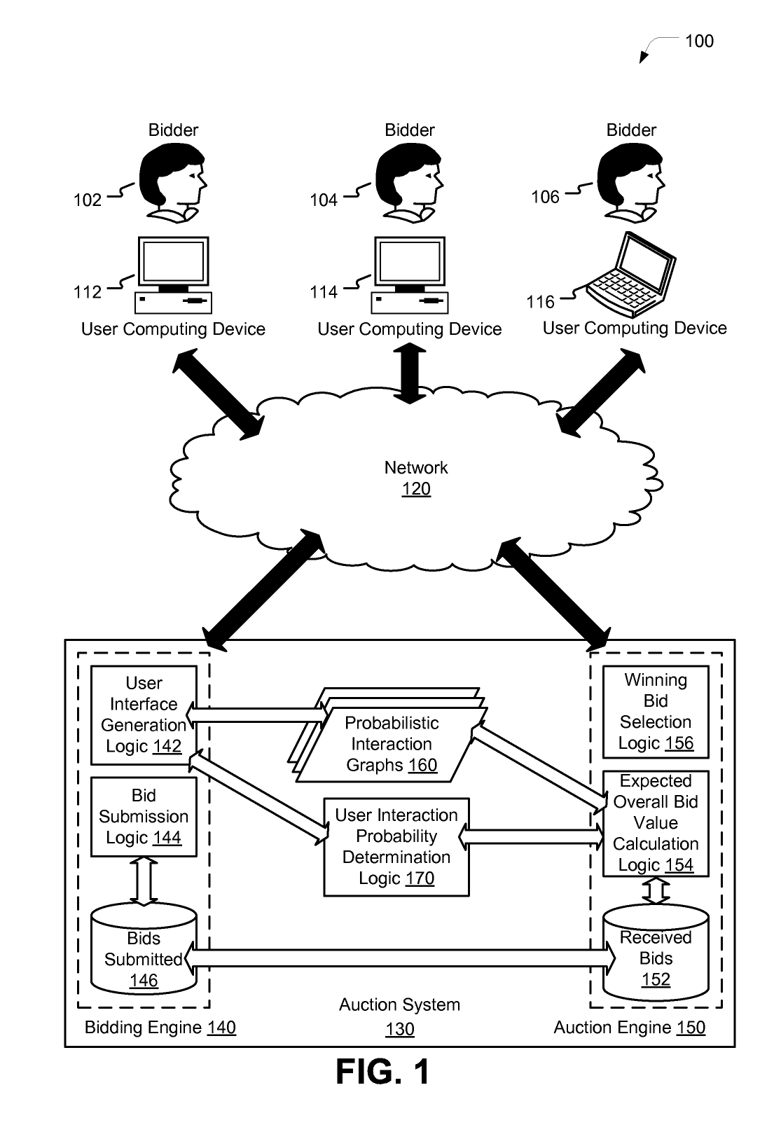

FIG. 1 is a block diagram of a system 100 of processing advertising bids based on user interactions. The system 100 includes user computing devices, such as the user computing devices 112, 114, and 116, communicatively coupled to an auction system 130 via a network 120. Each of the user computing devices is operated by a bidder. For example, in the particular embodiment illustrated in FIG. 1, the bidder 102 operates the user computing device 112, the bidder 104 operates the user computing device 114, and the bidder 106 operates the user computing device 116. Each of the user computing devices 112, 114, and 116 may send information to the auction system 130 via the network 120 and may receive information from the auction system 130 via the network 120. Generally, the system 100 includes a system of processing bids for an advertising opportunity based on user interactions.

The auction system 130 may include a bidding engine 140 and an auction engine 150. The bidding engine 140 may receive information from the user computing devices 112, 114, and 116 via the network 120. Both the bidding engine 140 and the auction engine 150 may send information via the network 120 to the user computing devices 112, 114, and 116. By way of example, and not limitation, the network 120 may be a local area network, a wide area network, or the Internet.

The bidding engine 140 may include user interface generation logic 142, bid submission logic 144, and storage for bids submitted 146. The user interface generation logic 142 may be configured to access the probabilistic interaction graphs 160 and the user interaction probability determination logic 170. The bid submission logic 144 may be configured to transmit submitted bids to the storage for bids submitted 146. The storage for bids submitted 146 may be configured to transmit submitted bids to a storage for received bids 152 at the auction engine 150.

The auction engine 150 may include the storage for received bids 152, expected overall bid value calculation logic 154, and winning bid selection logic 156. The storage for the received bids 152 may be configured to receive submitted bids from the storage for bids submitted 146 at the bidding engine 142 and transmit the received bids to the expected overall bid value calculation logic 154. In a particular embodiment, the storage for bids submitted 146 and the storage for received bids 152 may be located at the same physical storage location. The expected overall bid value calculation logic 154 may be configured to access the probabilistic interaction graphs 160 and the user interaction probability determination logic 170.

Each of the probabilistic interaction graphs 160 includes a plurality of nodes and a plurality of edges. Each node of the plurality of nodes may represent an available user interaction. Each edge of the plurality of edges may connect two nodes of the plurality of nodes and may have an associated user interaction probability. The user interaction probability associated with a particular edge connecting a first node and a second node may indicate the probability that a user that has performed a user interaction represented by the first node may then perform a user interaction represented by the second node. The user interaction probabilities associated with the edges may be determined by the user interaction probability determination logic 170. In a particular embodiment, the probabilistic interaction graphs 160 are submitted to the auction system 130 by bidders, such as the bidders 102, 104, and 106.

In operation, the user interface generation logic 142 may generate a user interface and transmit the user interface, via the network 120, to each of the bidders 102, 104 and 106 at their respective user computing devices 112, 114, and 116. In generating the user interface, the user interface generation logic 142 may access one or both of the probabilistic interaction graphs 160 and the user interaction probability determination logic 170. For example, the user interface generation logic 142 may access the probabilistic interaction graphs 160 and the user interaction probability generation logic 170 so that it may include in the generated user interface a portion of the probabilistic interaction graphs 160 and the user interaction probabilities determined by the user interaction probability determination logic 170. In a particular embodiment, the user interface generated by the user interface generation logic may not include any portion of the probabilistic interaction graphs 160 or any user interaction probabilities determined by the user interaction probability determination logic 170.

The bidders 102, 104 and 106 may submit bids for an advertising opportunity via the user interface. The bids submitted may be in the form of a probabilistic interaction graph defined by each of the bidders 102, 104, and 106 and may each include at least one bid amount corresponding to an available user interaction. The submitted bids may be received, via the network 120, at the bid submission logic 144. The bid submission logic may then transmit the submitted bids to the storage for bids submitted 146, which in turn may transmit them to the storage for the received bids 152 at the auction engine 150. The bid amounts in a particular bid may correspond to available user interactions of different types. For example, the bid amounts in a particular bid may correspond to views, selections, clicks, typing, specific requests, sending messages, and submitting information.

The expected overall bid value calculation logic 154 may calculate an expected overall bid value for each received bid in the storage for received bids 152. In calculating an expected overall bid value from each of the received bids, the expected overall bid value calculation logic 154 may access the probabilistic interaction graphs 160 and the user interaction probability determination logic 170. For example, when a received bid includes a bid amount corresponding to a particular available user interaction, the expected overall bid value calculation logic 154 may access the probabilistic interaction graphs 160 and the user interaction probability determination logic 170 to determine the user interaction probability associated with an edge connected to a node corresponding to that particular available user interaction. When the received bid includes more than one bid amount, the overall bid value calculation logic 154 may access the probabilistic interaction graphs 160 and the user interaction probability determination logic 170 to calculate an expected value for each individual bid amount by multiplying the bid amount by the user interaction probability of the user interaction associated with the bid amount, and then calculate the expected overall bid value by adding together the expected values for the individual bid amounts. It should be noted that it is not necessary for all edges of the probabilistic interaction graphs 160 to have a known user interaction probability. At any point in time, the user interaction probability associated with one or more of the edges may be unresolved or undefined. Further, different edges may have unresolved or undefined user interaction probabilities at different times.

After an expected overall bid value has been calculated for each of the received bids, the winning bid selection logic 156 may select a winning bid from the received bids on the basis of a highest expected overall bid value. When a winning bid is selected, the winning bid selection logic 156 may notify a winning bidder associated with the winning bid that they have been awarded the advertising opportunity. For example, the winning bid selection logic 156 may notify one of the bidders 102, 104, or 106 that they have been awarded the advertising opportunity.

It will be appreciated that the system of FIG. 1 provides bidders with an interface that enables them to bid on advertising opportunities on the basis of user interactions. It will also be appreciated that the system of FIG. 1 is capable of representing each particular available user interaction and the probability that each particular user interaction will be performed in a single graph, e.g. one of the probabilistic interaction graphs 160.

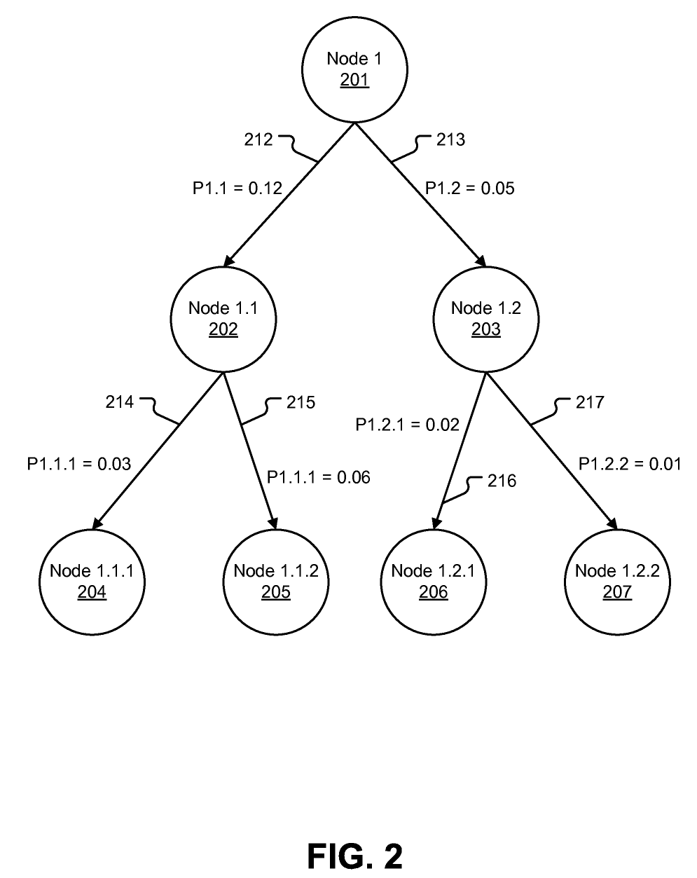

FIG. 2 is an illustration of a particular embodiment of a probabilistic interaction graph 200 that may be used in processing advertising bids based on user interactions. The probabilistic interaction graph 200 may include a plurality of nodes connected by a plurality of edges. In an illustrative embodiment, the probabilistic interaction graph 200 may include one of the probabilistic interaction graphs 160 of FIG. 1.

The probabilistic interaction graph 200 includes a plurality of nodes. For example, in the particular embodiment illustrated in FIG. 2, the probabilistic interaction graph 200 includes the seven nodes 201, 202, 203, 204, 205, 206, and 207. The probabilistic interaction graph 200 also includes a plurality of edges. For example, in the particular embodiment illustrated in FIG. 2, the probabilistic interaction graph 200 includes the six edges 212, 213, 214, 215, 216, and 217. The probabilistic interaction graph may also represent the relationship between nodes. For example, in the particular embodiment illustrated in FIG. 2, the node 201 is a parent node of its child node 202 and its child node 203. In a particular embodiment, one or more of the nodes or edges may be displayed in the user interface generated by the user interface generation logic 142 of FIG. 1. In another particular embodiment, the probabilistic interaction graph 200 may be displayed to an administrative console of the auction system 130 of FIG. 1 that is accessible by authorized operators of the auction system 130 of FIG. 1.

Each node of the probabilistic interaction graph 200 may represent an available user interaction, and each edge of the probabilistic interaction graph 200 may have an associated user interaction probability. For example, in the particular embodiment illustrated in FIG. 2, the edge 212 that connects the nodes 201 and 202 has an associated user interaction probability P1.1=0.12. P1.1=0.12 indicates that there is a 12% chance that a user who has performed an available user interaction corresponding to the node 201 will then perform an available user interaction corresponding to the node 202. In a particular embodiment, one or more of the user interaction probabilities may be displayed in the user interface generated by the user interface generation logic 142 of FIG. 1.

It should be noted that although the particular probabilistic interaction graph 200 illustrated in FIG. 2 includes a plurality of nodes and a plurality of edges, probabilistic interaction graphs may be much simpler. For example, a probabilistic interaction graph may be a one-layer tree with one root node and one or more leaf nodes attached to the root node, without any intervening nodes or edges between the root node and the leaf nodes. It should also be noted that the edges of a probabilistic interaction graph may represent a multi-step transition. In this embodiment, the user interaction probability associated with the edge between N1 and N2 corresponds to multiple possible user interaction sequences that begin at N1 and end at N2.

It will be appreciated that the probabilistic interaction graph 200 of FIG. 2 may provide a uniform representation of available user interactions, user interaction probabilities, and the relationship between available user interactions. Further, it will be noted that while the probabilistic interaction graph 200 of FIG. 2 is a directed acyclic graph, this need not always be the case. Probabilistic interaction graphs may be any type of graph that may be used to represent available user interactions, user interaction probabilities, and the relationship between available user interactions. In a particular embodiment, a bidder may submit the probabilistic interaction graph 200. The submitted probabilistic interaction graph 200 may not represent an exhaustive set of every available user interaction. Instead, the submitted probability interaction graph 200 may only include available user interactions or a subset of available user interactions that are meaningful to the bidder.

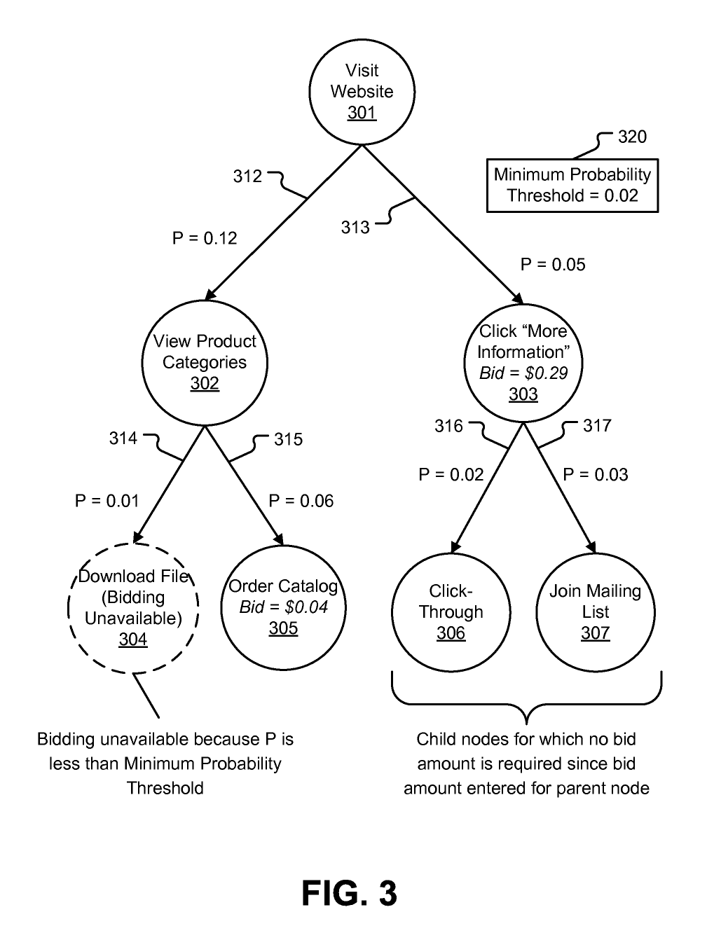

FIG. 3 is an illustration of another particular embodiment of a probabilistic interaction graph 300 that may be used in processing advertising bids based on user interactions. The probabilistic interaction graph 300 includes a plurality of nodes connected by a plurality of edges. In an illustrative embodiment, the probabilistic interaction graph 300 may include one of the probabilistic interaction graphs 160 of FIG. 1.

In the particular embodiment illustrated in FIG. 3, the probabilistic interaction graph 300 includes the nodes 301, 302, 303, 304, 305, 306, and 307. The probabilistic interaction graph may also include a plurality of edges. For example, in the particular embodiment illustrated in FIG. 3, the probabilistic interaction graph 300 includes the edges 312, 312, 314, 315, 316, and 317. In a particular embodiment, the probabilistic interaction graph 300 may optionally include a minimum probability threshold 320. For example, in the particular embodiment illustrated in FIG. 3, the probabilistic interaction graph 300 includes the minimum probability threshold 320 of 0.02. The minimum probability threshold 320 of 0.02 indicates that bidding will not be available for available user interactions represented by nodes that have an edge connected to it with a user interaction probability of less than 2%.

The nodes of the probabilistic interaction graph 300 may correspond to available user interactions. By way of example, and not limitation, available user interactions may include user interactions capable of being performed by a website, a game, a computer application, or a mobile device. Available user interactions include, but are not limited to, interacting with an interactive advertisement, viewing a particular webpage, selecting an option from a menu, clicking on a selector, clicking on a link, typing in a text field, making a specific request, sending a message, and submitting information.

In the particular embodiment illustrated in FIG. 3, the probabilistic interaction graph 300 represents available user interactions at a website. For example, the node 301 represents the available user interaction of visiting the website. The node 301 has two child nodes: node 302 and node 303. The node 302 represents the available user interaction of viewing product categories at the website and the node 303 represents the available user interaction of clicking on “More Information” at the website. The nodes 301 and 302 are connected by the edge 312 that has an associated user interaction probability of 0.12, and the nodes 301 and 303 are connected by the edge 313 that has an associated user interaction probability of 0.05. In a particular embodiment, the user interaction probabilities 0.12 and 0.05 represent the probability that a user that has performed the user interaction of viewing the website will then perform the user interaction of viewing product categories or clicking on “More Information,” respectively. In other words, there is a 12% chance that a user who visits the website will view product categories at the website, and there is a 5% chance that a user that visits the website will click on “More Information” at the website.

The node 302 has two child nodes: the node 304, which represents the available user interaction of downloading a file from the website, and the node 305, which represents the available user interaction of ordering a catalog via the website. The nodes 302 and 304 are connected by the edge 314 that has an associated user interaction probability of 0.01, and the nodes 302 and 315 are connected by the edge 315 that has an associated user interaction probability of 0.06. In a particular embodiment, the user interaction probabilities 0.01 and 0.06 may represent the probability that a user that has performed the user interaction of viewing product categories will then perform the user interaction of downloading a file or ordering a catalog, respectively. In other words, there is a 1% chance that a user who views product categories at the website will then download a file, and there is a 5% chance that a user that who views product categories at the website will order a catalog.

The node 303 has two child nodes: the node 306, which represents the available user interaction of clicking through the “More Information,” and the node 307, which represents the available user interaction of joining a mailing list. The nodes 303 and 306 are connected by the edge 316 that has an associated user interaction probability of 0.02, and the nodes 303 and 307 are connected by the edge 317 that has an associated user interaction probability of 0.03. In a particular embodiment, the user interaction probabilities of 0.02 and 0.03 represent the probability that a user that has performed the user interaction of clicking on “More Information” will then perform the user interaction of clicking through the “More Information” or joining a mailing list, respectively. In other words, there is a 2% chance that a user who has clicked on “More Information” will click through, and there is a 3% chance that a user who has clicked on “More Information” will join a mailing list.

It will be noted that in a particular embodiment, a cumulative user interaction probability for any particular available user interaction may be calculated by multiplying the user interaction probabilities for each edge that must be traversed to reach the particular user interaction. For example, the cumulative user interaction probability for ordering a catalog, i.e. the probability that a user who visits the website will go on to order a catalog, may be calculated by multiplying the user interaction probability of the edge 312 (12%) with the user interaction probability of the edge 315 (6%) which equals 0.72%.

In operation, the probabilistic interaction graph 300 may be displayed via the user interface generated by the user interface generation logic 142 of FIG. 1 to one or more bidders, such as the bidders 102, 104, and 106 of FIG. 1. In another particular embodiment, the nodes and edges of the probabilistic interaction graph 300 may be displayed, but the user interaction probabilities for each edge may not be displayed. In another particular embodiment, no part of the probabilistic interaction graph 300 may be displayed to the bidders. The one or more bidders may submit bids that include bid amounts corresponding to the user interactions represented by the nodes of the probabilistic interaction graph 300. For example, the bidders 102, 104, and 106 may submit bids that include bid amounts corresponding to the user interactions represented by one or more of the nodes 301, 302, 303, 304, 305, 306, or 307.

In the particular embodiment illustrated in FIG. 3, a bidder has placed a bid amount of $0.29 on the available user interaction of clicking on “More Information,” represented by the node 303, and a bid amount of $0.04 on the available user interaction of ordering a catalog, represented by the node 305.

In a particular embodiment where the probabilistic interaction graph 300 is displayed to bidders via a user interface, when a bid amount is received from a bidder for a parent node of one or more child nodes, the one or more child nodes may be marked to notify the bidder that bids are not required for the one or more child nodes. For example, in the particular embodiment illustrated in FIG. 3, because a bid amount of $0.29 has been received for the user interaction of clicking on “More Information,” the nodes 306 and 307 are grayed-out to indicate that no bid amount is required for either the available user interaction of clicking through “More Information” or the available user interaction of join a mailing list. No bid amount may be required for clicking through or joining a mailing list because the bid amount of $0.29 may automatically be placed for the nodes 306 and 307 when the bid is submitted.

In a case where the probabilistic interaction graph 300 is a depth-1 tree (e.g., one or more leaf nodes connected to a root node without any intervening nodes), the probabilistic interaction graph 300 may be displayed to the user as a flat list of nodes. The flat list of nodes may include the root nodes and each of the leaf nodes.

In another particular embodiment where the probabilistic interaction graph 300 is displayed to bidders via a user interface, any node connected to an edge that has an associated user interaction probability less than the minimum probability threshold 320 may be marked to notify bidders that bidding for the available user interaction corresponding to that node is not possible. For example, in the particular embodiment illustrated in FIG. 3, the available user interaction of downloading a file, represented by the node 304, has been drawn in a dashed line to indicate that bidding for it is unavailable, because the edge 314 connected to the node 304 has a user interaction probability of 0.01, which is less than the minimum probability threshold 320 of 0.02.

It will be appreciated that the probabilistic interaction graph 300 of FIG. 3 may be displayed to bidders via a user interface so that bidders may see the relationship between available user interactions while bidding on them. It will also be appreciated that the probabilistic interaction graph 300 may support functionality that simplifies the bidding process for bidders, such as marking child nodes of parent nodes that have been bid on and marking nodes for which bidding is unavailable.

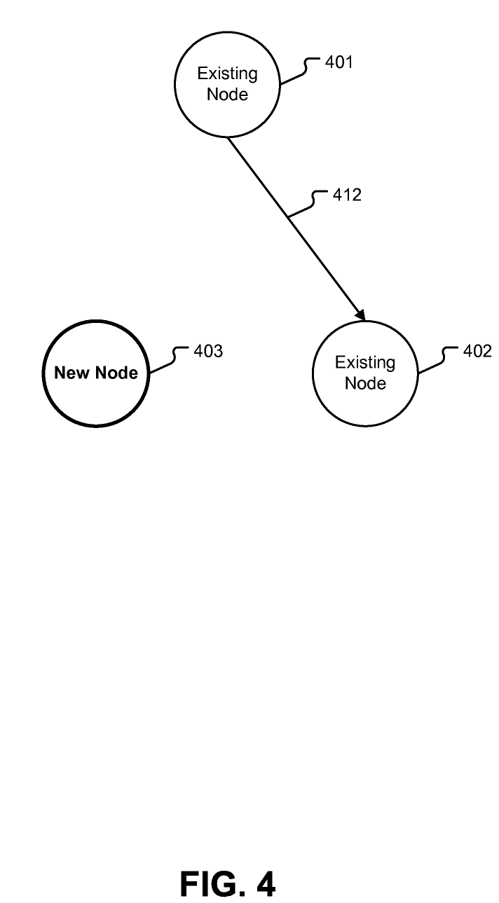

FIG. 4 is an illustration of a particular embodiment of a method of modifying an existing probabilistic interaction graph that may be used in processing advertising bids based on user interactions. The method may be performed by a user interface 400 that may display the existing nodes and the existing edges of an existing probabilistic interaction graph. In an illustrative embodiment, the existing probabilistic interaction graph may include one of the probabilistic interaction graphs 160 of FIG. 1.

In the particular embodiment illustrated in FIG. 4, the user interface 400 displays the existing node 401 and the existing node 402 that is a child node of the existing node 401. The user interface 400 also displays the existing edge 412 that connects the existing node 401 and the existing node 402.

In operation, the user interface 400 may include an option to insert a new node into an existing probabilistic interaction graph. For example, in the particular embodiment illustrated in FIG. 4, the user interface 400 has been used to insert the new node 403 into the existing probabilistic interaction graph. The user interface may also include an option to delete an existing node or change an existing node by relocating the node or changing the available user interaction that the node represents. In a particular embodiment, the user interface 400 may be included in the user interface generated by the user interface generation logic 142 of FIG. 1 and displayed to the bidders 102, 104, and 106 of FIG. 1. In another particular embodiment, the user interface 400 may be displayed to an administrative console of the auction system 130 of FIG. 1 that is accessible by authorized operators of the auction system 130 of FIG. 1.

It will be appreciated that the method of FIG. 4 enables the creation, removal, and modification of nodes in a probabilistic interaction graph. It will also be appreciated that the method of FIG. 4 provides a way to change a probabilistic interaction graph so that it may keep up with changes in available user interactions.

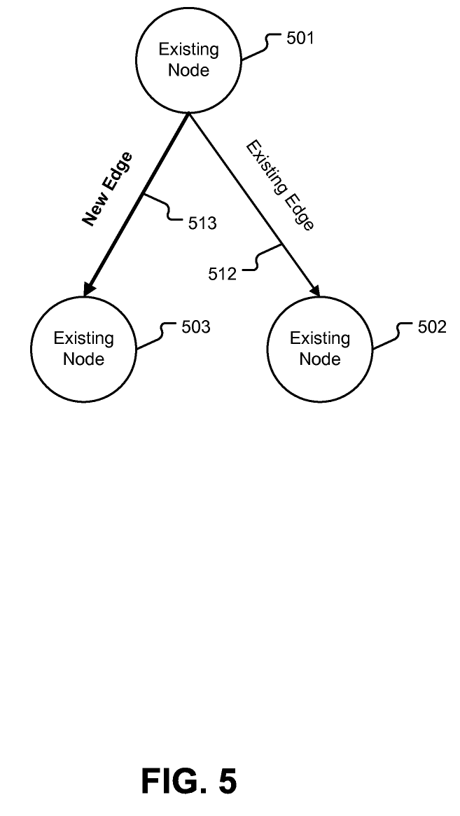

FIG. 5 is an illustration of another particular embodiment of a method of modifying an existing probabilistic interaction graph that may be used in processing advertising bids based on user interactions. The method may be performed by a user interface 500 that may display the existing nodes and the existing edges of an existing probabilistic interaction graph. In an illustrative embodiment, the existing probabilistic interaction graph may include one of the probabilistic interaction graphs 160 of FIG. 1.

In the particular embodiment illustrated in FIG. 5, the user interface 500 displays the existing nodes 501, 502, and 503. The existing node 501 is a parent node of the existing node 502 and the existing node 503. The user interface 500 also displays the existing edge 512 that connects the existing nodes 501 and 502.

In operation, the user interface 500 may include an option to insert a new edge into an existing probabilistic interaction graph. For example, in the particular embodiment illustrated in FIG. 5, the user interface 500 has been used to insert the new edge 513 has been inserted into the existing probabilistic interaction graph to connect the existing node 501 and the existing node 503. The user interface may also include an option to delete an existing edge or change an existing edge by changing the nodes that it connects. It should be noted that the user interaction probability associated with the new edge 513 may be calculated automatically, e.g., by the user interaction probability logic 170 of FIG. 1. In a particular embodiment, the user interface 500 may be included in the user interface generated by the user interface generation logic 142 of FIG. 1 and displayed to the bidders 102, 104, and 106 of FIG. 1. In another particular embodiment, the user interface 500 may be displayed to an administrative console of the auction system 130 of FIG. 1 that is accessible by authorized operators of the auction system 130 of FIG. 1.

It will be appreciated that the method of FIG. 5 enables the creation and modification of edges in a probabilistic interaction graph. It will also be appreciated that when the options to add, delete, and modify nodes from the method of FIG. 4 and the options to add, delete, and modify edges from the method of FIG. 5 are presented to bidders simultaneously, bidders then have the ability submit bids for advertising opportunities in the form of graphs. Thus, a bidder may submit more than one probabilistic interaction graph, and a bidder may also submit different probabilistic interaction graphs for different advertising opportunities. This simplifies processing bids at an auction system, since the relationship between the available user interactions that a bidder is interested in will have been provided in the submitted bid graph. It will also be appreciated that when the options to add, delete and modify nodes from the method of FIG. 4 and the options to add, delete, and modify edges from the method of FIG. 5 are presented to authorized operators of the auction system 130 of FIG. 1 simultaneously, the authorized operators may modify the probabilistic interaction graphs 160 that such operators submitted before the graphs are used by the bidding engine 140 of FIG. 1 or the auction engine 150 of FIG. 1. This allows the probabilistic interaction graphs 160 to be kept current with changes to advertising campaigns and advertising opportunities that may change from time to time.

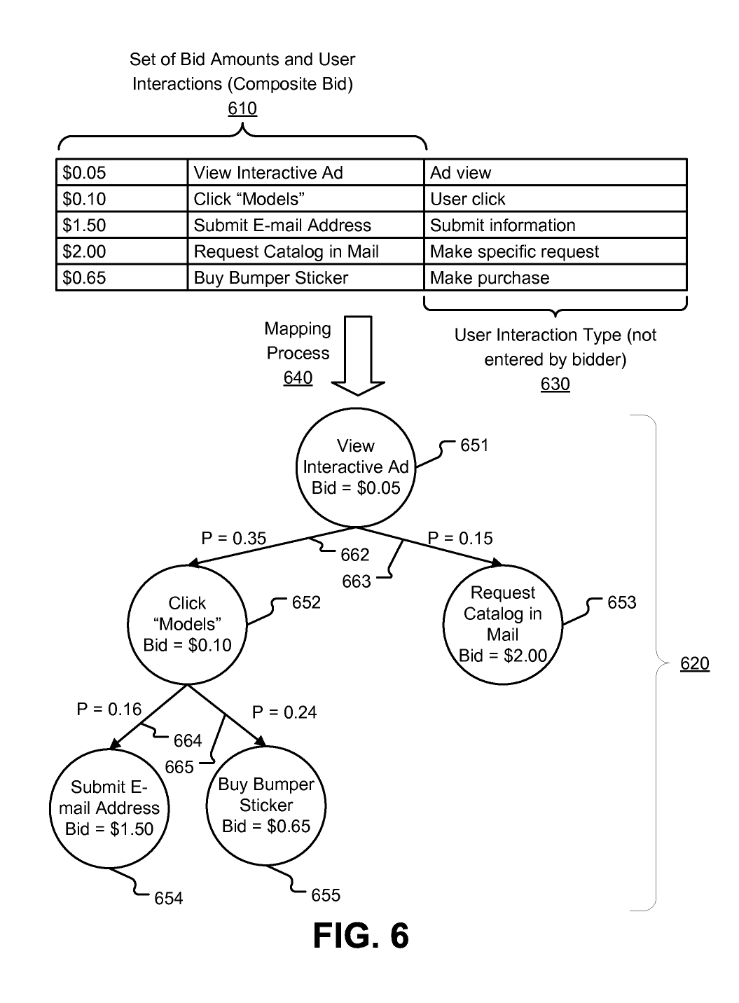

FIG. 6 is a diagram 600 to illustrate a particular example of mapping a composite bid based on user interactions to a probabilistic interaction graph. A mapping process 640 may map a composite bid 610 to a probabilistic interaction graph 620. In an illustrative embodiment, one of the bidders 102, 104, or 106 of FIG. 1 may have submitted the composite bid 610 via a user interface generated by the user interface generation logic 142 of FIG. 1. In an illustrative embodiment, the probabilistic interaction graph 620 may include one of the probabilistic interaction graphs 160 of FIG. 1, and the mapping process 640 may be performed by the bid submission logic 144 of FIG. 1.

The composite bid 610 may include a set of bid amounts and available user interactions without including the relationship between the available user interactions. For example, in the particular embodiment illustrated in FIG. 6, the composite bid 610 includes the bid amount $0.05 associated with the available user interaction of viewing an interactive ad, the bid amount $0.10 associated with the available user interaction of clicking on “Models,” the bid amount $1.50 associated with the available user interaction of submitting an e-mail address, the bid amount $2.00 associated with the available user interaction of requesting a catalog in the mail, and the bid amount $0.65 associated with the available user interaction of buying a bumper sticker; without including information regarding relationships between those available user interactions.

Each of the available user interactions in the composite bid 610 may have an associated user interaction type 630. Furthermore, a particular available user interaction in the composite bid 610 may have a different user interaction type 630 than another available user interaction in the composite bid 610. For example, in the particular embodiment illustrated in FIG. 6, viewing an interactive ad has the user interaction type “Ad view,” clicking on “Models” has the user interaction type “User click,” submitting an e-mail address has the user interaction type “Submit information,” requesting a catalog in the mail has the user interaction type “Make specific request,” and buying a bumper sticker has the user interaction type “Make purchase.”

The probabilistic interaction graph 620 may include a plurality of nodes connected by a plurality of edges, each node of the probabilistic interaction graph 620 representing one of the user interactions in the composite bid 610. For example, in the particular embodiment illustrated in FIG. 6, the probabilistic interaction graph 620 includes the nodes 651, 652, 653, 654, and 655, and the edges 662, 663, 664, and 665.

In operation, a bidder submits the composite bid 610. For example, one of the bidders 102, 104, or 106 may submit the composite bid 610. As mentioned previously, the composite bid 610 includes a set of bid amounts and available user interactions for the bid amounts without including any information about the relationship between any of the available user interactions.

In response to receiving the composite bid 610, the mapping process 640 may map the composite bid 610 to the probabilistic interaction graph 620, by determining what relationships, if any, exist between the available user interactions in the composite bid 610. For example, in the particular embodiment illustrated in FIG. 6, the mapping process 640 determines that the user interaction of viewing an interactive ad should correspond to the node 651 of the probabilistic interaction graph 620. Node 651 is a root node of the probabilistic interaction graph 620. Similarly, the mapping process 640 determines where nodes corresponding to each of the other available user interactions in the composite bid 610 should be inserted. The mapping process 640 also determines the user interaction probability associated with each of the edges 662, 663 664, and 665 of the probabilistic interaction graph 620 that connect the nodes. For example, the mapping process 640 determines that the associated user interactive probability for the edge 662 that connects the node 651 and the node 652 is equal to 0.35.

It will be appreciated that by implementing the mapping process 640 of FIG. 6, auction systems, such as the auction system 130 of FIG. 1 may simplify the bidding process for bidders such as the bidders 102, 104, and 106 of FIG. 1. Instead of submitting bids in the form of graphs, which requires an understanding of the relationship between different available user interactions, bidders may submit composite bids in a simple form, such as the composite bid 610, and the auction system may process the composite bids by mapping them to a probabilistic interaction graph.

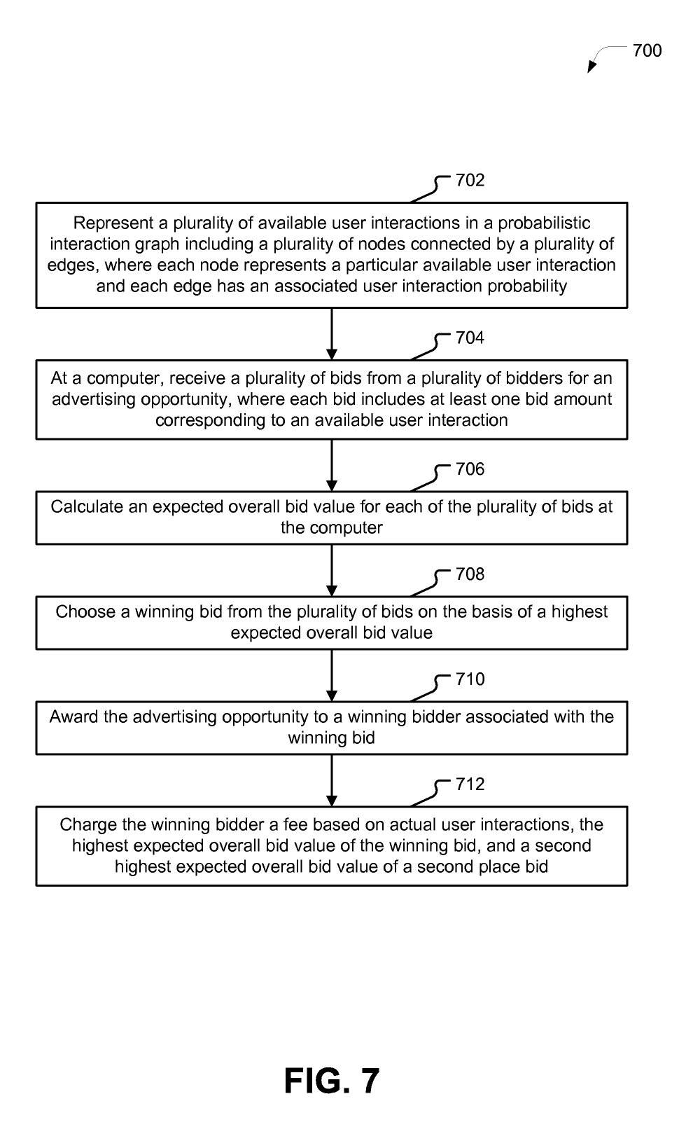

FIG. 7 is a flow diagram of a particular embodiment of a method of processing advertising bids based on user interactions. In an illustrative embodiment, the method 700 may be performed by the auction system 130 of FIG. 1. The method includes representing a plurality of available user interactions in a probabilistic interaction graph, at 702. Each bidder (e.g., each individual advertiser) may represent available user interactions in a different probabilistic interaction graph. The probabilistic interaction graph includes a plurality of nodes connected by a plurality of edges, where each node represents a particular available user interaction and each edge has an associated user interaction probability. For example, the plurality of available user interactions may be represented in one of the probabilistic interaction graphs 160 of FIG. 1, the probabilistic interaction graph 300 of FIG. 3, or the probabilistic interaction graph 620 of FIG. 6. The method also includes receiving a plurality of bids from a plurality of bidders for an advertising opportunity at a computer, at 704. Each bid includes at least one bid amount corresponding to an available user interaction. For example, a plurality of bids from the bidders 102, 104, and 106 of FIG. 1 may be received at a computer that includes the auction system 130 of FIG. 1. The method also includes calculating an expected overall bid value for each of the plurality of bids at the computer, at 706. For example, the expected overall bid value calculation logic 154 of FIG. 1 may calculate an expected overall bid value for each of the bids received at the computer. The method also includes choosing a winning bid from the plurality of bids on the basis of a highest expected overall bid value, at 708. For example, the winning bid selection logic 156 of FIG. 1 may select a winning bid on the basis of a highest overall bid value from the expected overall bid values calculated for the bids submitted by the bidders 102, 104, and 106 of FIG. 1.

The method also includes awarding the advertising opportunity to a winning bidder associated with the winning bid, at 710. For example, the advertising opportunity may be awarded to a winning bidder associated with the winning bid, where the winning bidder is one of the bidders 102, 104, and 106 of FIG. 1. The method also includes charging the winning bidder with a fee, at 712. In a particular embodiment, the fee charged to the winning bidder is based on actual user interactions, the highest expected overall bid value of the winning bid, and a second highest expect overall bid value of a second place bid. For example, when the winning bidder is the bidder 102 of FIG. 1 and the bidder 104 of FIG. 1 placed a bid with the second highest expected overall bid value, then the winning bidder 102 may be charged a fee based on actual user interactions, the expected overall bid value of the bid submitted by the winning bidder 102 of FIG. 1, and the expected overall bid value of the bid submitted by the second place bidder 104 of FIG. 1.

In a particular embodiment, the fee may be calculated using a generalized second price auction scheme that incentivizes truthful bidding. Alternately, the fee charged may be calculated using more complex or alternative schemes. For example, when the fee is calculated using a generalized second price auction scheme, if the winning bid includes a single bid amount of $20.00 for the available user interaction of clicking on a banner, which has a user interaction probability of 10%, then the highest expected overall bid value of the winning bid would be $2.00. If the expected overall bid value of the second place bid is $0.50, then the fee charged per actual banner click may not be $20.00, but rather $5.00, which equals $20.00 multiplied by the ratio (1/4) of the expected overall bid value of the second place bid ($0.50) to the highest expected overall bid value ($2.00). That is, for a bid amount B, an expected overall bid value of the winning bid V1, and an expected overall bid value of the second place bid V2, the fee charged F may be computed by the equation F=B*(V2/V1). It will be appreciated that the fee calculation scheme may ensure that a winning advertiser is not charged a fee greater than a submitted bid amount.

For example, when there are N advertising opportunities available, the fee may be calculated utilizing a Vickrey-Clarke-Groves (VCG) auction mechanism. When the VCG auction mechanism is used, each bidder that is awarded one of the N advertising opportunities is charged an opportunity cost associated with that bidder's presence in the auction. That is, each bidder that is awarded an advertising opportunity is charged the difference of the sum of expected overall bid values if the bidder had not placed a bid for the awarded advertising opportunity and the sum of expected overall bid values due to the bidder's having placed a bid for the awarded advertising opportunity.

It will be appreciated that the method of FIG. 7 enables bidders to bid on advertising opportunities on the basis of user interactions and, if they are awarded an advertising opportunity, be charged a fee based on actual user interactions, i.e. those available user interactions present in the winning bid that are actually performed by users. Furthermore, it will be appreciated that by also basing the charged fee on a generalized second price mechanism or a VCG mechanism, the method of FIG. 7 gives bidders an incentive to submit bid amounts for available user interactions that correspond to the true value of those available user interactions to each of the bidders.

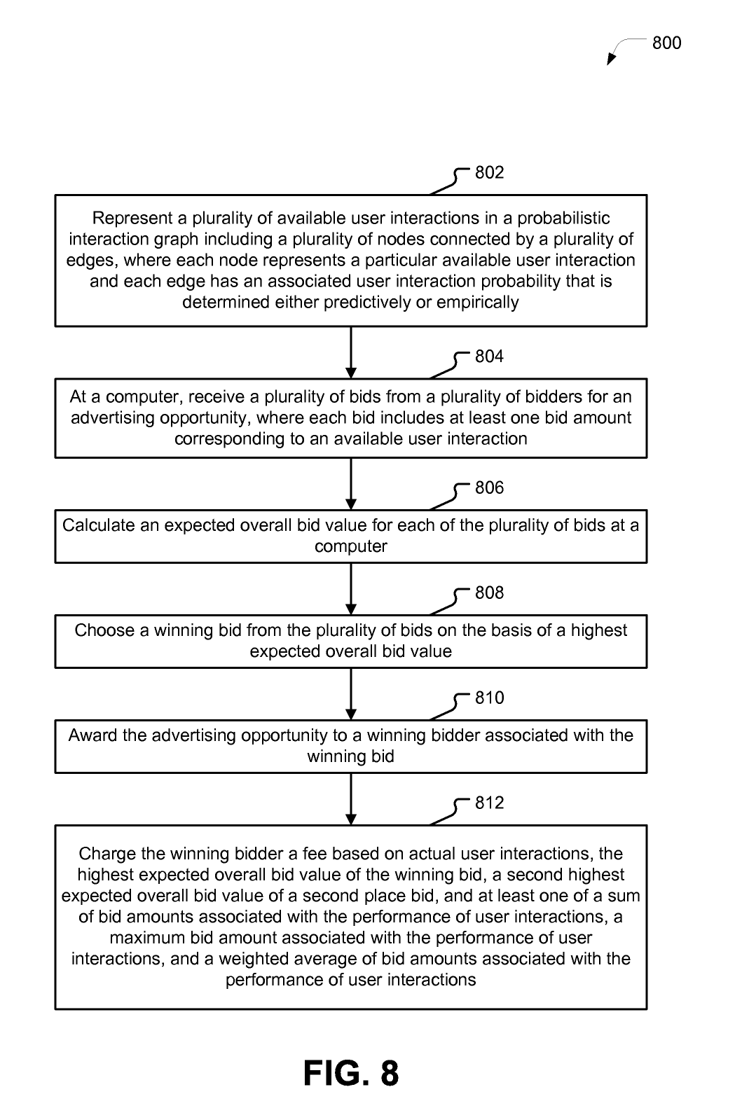

FIG. 8 is a flow diagram of another particular embodiment of a method 800 of processing advertising bids based on user interactions. In an illustrative embodiment, the method 800 may be performed by the auction system 130 of FIG. 1. The method includes representing a plurality of available user interactions in a probabilistic interaction graph, at 802. The probabilistic interaction graph includes a plurality of nodes connected by a plurality of edges, where each node represents a particular available user interaction and each edge has an associated user interaction probability that may be determined empirically or predictively. For example, the plurality of available user interactions may be represented in one of the probabilistic interaction graphs 160 of FIG. 1, the probabilistic interaction graph 300 of FIG. 3, or the probabilistic interaction graph 620 of FIG. 6, and the user interaction probabilities of the probabilistic interaction graph may be determined by the user interaction probability determination logic 170 of FIG. 1 either empirically or predictively.

The method also includes receiving a plurality of bids from a plurality of bidders for an advertising opportunity, at 804. Each bid includes at least one bid amount corresponding to an available user interaction. For example, a plurality of bids from the bidders 102, 104, and 106 of FIG. 1 may be received at a computer that includes the auction system 130 of FIG. 1. The method also includes calculating an expected overall bid value for each of the plurality of bids at the computer, at 806. For example, the expected overall bid value calculation logic 154 of FIG. 1 may calculate an expected overall bid value of each of the bids received at the computer that includes the auction system 130 of FIG. 1. The method also includes choosing a winning bid from the plurality of bids on the basis of a highest expected overall bid value, at 808. For example, the winning bid selection logic 156 of FIG. 1 may select a winning bid on the basis of a highest overall bid value from the expected overall bid values calculated for the bids submitted by the bidders 102, 104, and 106 of FIG. 1. The method also includes awarding the advertising opportunity to a winning bidder associated with the winning bid, at 810. For example, the advertising opportunity may be awarded to a winning bidder associated with the winning bid, where the winning bidder is one of the bidders 102, 104, and 106 of FIG. 1.

The method also includes charging the winning bidder a fee, at 812. In a particular embodiment, the fee charged to the winning bidder is based on actual user interactions, the highest expected overall bid value of the winning bid, and a second highest expected overall bid value of a second place bid. The fee charged to the winning bidder is also based on a sum of bid amounts associated with the performance of user interactions, or a maximum bid amount associated with the performance of user interactions. For example, when the winning bidder is the bidder 102 of FIG. 1 and the bidder 104 of FIG. 1 placed a bid with the second highest expected overall bid value, then the winning bidder 102 may be charged a fee based on actual user interactions, the expected overall bid value of the bid submitted by the winning bidder 102 of FIG. 1, and the expected overall bid value of the bid submitted by the second place bidder 104 of FIG. 1. Furthermore, the fee charged to the winning bidder 102 may be also be based on the sum of bid amounts present in the winning bid that correspond to available user interactions actually performed by users or the maximum bid amount present in the winning bid that corresponds to an available user interaction actually performed by users.

For example, if the winning bid includes three bid amounts, equal $1.00, $2.00, and $6.00, then the sum of bid amounts would equal $9.00 and the maximum bid amount would equal $6.00.

It will be appreciated that the method of FIG. 8 enables an auction system to use user interaction probabilities that are determined either empirically, i.e. based on actual user interaction data, or predictively, i.e. based on past user interaction probabilities. For example, when the user interaction probabilities are determined predictively, the user interaction probability for a particular available user interaction may be determined based on a past user interaction probability for the particular available user interaction or based on a past user interaction probability for a user interaction similar to the particular available user interaction. It will also be appreciated that the method of FIG. 8 enables an auction system to implement various fee structures for advertisers, such as sum of bid amounts and a maximum bid amount, giving advertisers greater flexibility when planning their advertising campaigns.

In a case where the user interaction probabilities are determined empirically, determining an expected overall bid value may include calculating a confidence interval with a minimal confidence based on the empirical data for individual edges, aggregating all such confidence intervals for a bid, and using the aggregated confidence intervals to determine an expected overall bid value. For example, if the minimal confidence is 99.5% (i.e., 0.995) and the confidence interval is bound by a probability value P1 on the high end and a probability value P2 on the low end, then it can be said with 99.5% certainty that the expected overall bid value is at least P2. Furthermore, when a second highest bid has a confidence value bound by Q1 and Q2, it can be said with 99.5% certainty that the two highest expected bid values are at least equal to P2 and Q1, respectively.

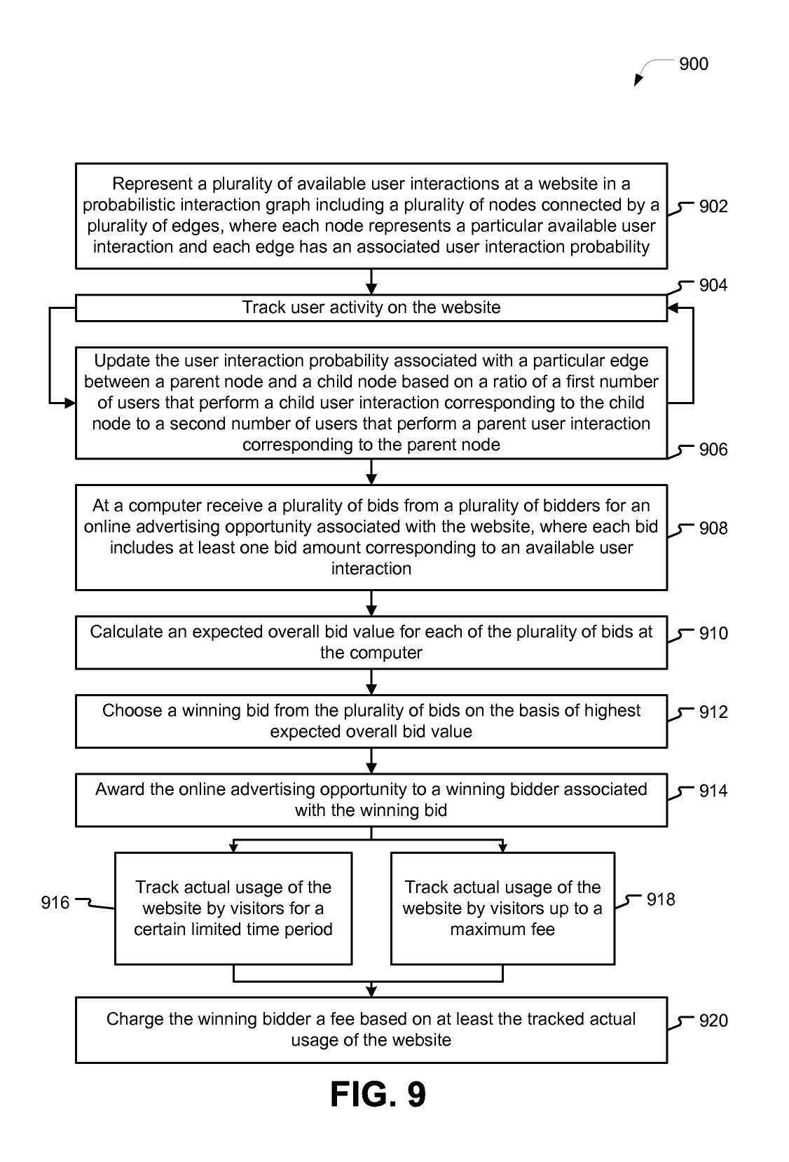

FIG. 9 is a flow diagram of a particular embodiment of a method of processing advertising bids based on user interactions at an auction system that is capable of tracking user activity at a plurality of websites. In an illustrative embodiment, the method may be performed by the auction system 130 of FIG. 1. The auction system 130 of FIG. 1 may be configured to track user activity at a website, including the number of users that perform an available user interaction, and this information may be used to continuously update the probabilities and structure (e.g., nodes and edges) of the probabilistic interaction graphs 160 of FIG. 1. The method includes representing a plurality of available user interactions at a website in a probabilistic interaction graph, at 902. The probabilistic interaction graph includes a plurality of nodes connected by a plurality of edges, where each node represents a particular available user interaction and each edge has an associated user interaction probability. For example, a plurality of available user interactions at a website may be represented in the probabilistic interaction graphs 160 of FIG. 1, the probabilistic interaction graph 300 of FIG. 3, or the probabilistic interaction graph 620 of FIG. 6. The method may also include tracking user activity at the website, at 904, and using the tracked activity to update the user interaction probabilities associated with a particular edge between a parent node and a child node, at 906. The user interaction probability is updated based on a ratio of a first number of users that perform a child user interaction corresponding to the child node to a second number of users that perform a parent user interaction corresponding to the parent node. Tracking user activity at the website at 904 and updating user interaction probabilities at 906 continues until bids are received. As described herein, there are a multitude of methods to update, estimate, and predict the user interaction probabilities.

Advancing to 908, the method includes receiving a plurality of bids from a plurality of bidders for an online advertising opportunity associated with the website. Each bid includes at least one bid amount corresponding to an available user interaction. For example, a plurality of bids from the bidders 102, 104, and 106 of FIG. 1 may be received at the computer that includes the auction system 130 of FIG. 1. The method also includes calculating an expected overall bid value for each of the plurality of bids at the computer, at 910. For example, the expected overall bid value calculation logic 154 of FIG. 1 may calculate an expected overall bid value for each of the bids received at the computer that includes the auction system 130 of FIG. 1. The method also includes choosing a winning bid from the plurality of bids on the basis of a highest expected overall bid value, at 912. For example, the winning bid selection logic 156 of FIG. 1 may select a winning bid on the basis of a highest overall bid value from the expected overall bid values calculated for the bids submitted by the bidders 102, 104, and 106 of FIG. 1. The method also includes awarding the online advertising opportunity to a winning bidder associated with the winning bid, at 914. For example, the advertising opportunity associated with the website may be awarded to a winning bidder associated with the winning bid, where the winning bidder is one of the bidders 102, 104, and 106 of FIG. 1.

In a particular embodiment, it may be determined that the advertising opportunity associated with the website should be awarded to the winning bidder for a certain limited time period. When that is the case, the method includes tracking actual usage of the website where the bidder's advertisement is displayed by visitors for the certain limited time period, at 916, and charging the winning bidder a fee based on the tracked actual usage of the website where the advertisement is displayed for the limited time period, at 920. In another particular embodiment, it may be determined that the winning bidder only wishes to have the awarded advertising opportunity up to a maximum charged fee. When that is the case, the method includes tracking actual usage of the website by visitors up to the maximum fee, at 918, and charging the winning bidder a fee based on at least the tracked actual usage of the website, at 920.

It will be appreciated that the method of FIG. 9 provides for the dynamic updating of user interaction probabilities based on observed user activity at a website, resulting in up to date probabilistic interaction graphs. It will also be appreciated that the method of FIG. 9 enables an auction system to implement various fee structures for advertisers, such as advertising for a limited time period and advertising up to a maximum fee, giving advertisers greater flexibility when planning their advertising campaigns. It will further be appreciated that the method 700 of FIG. 7, the method 800 of FIG. 8, and the method 900 of FIG. 9, or portions thereof, may be combined to provide even more flexibility to advertisers.

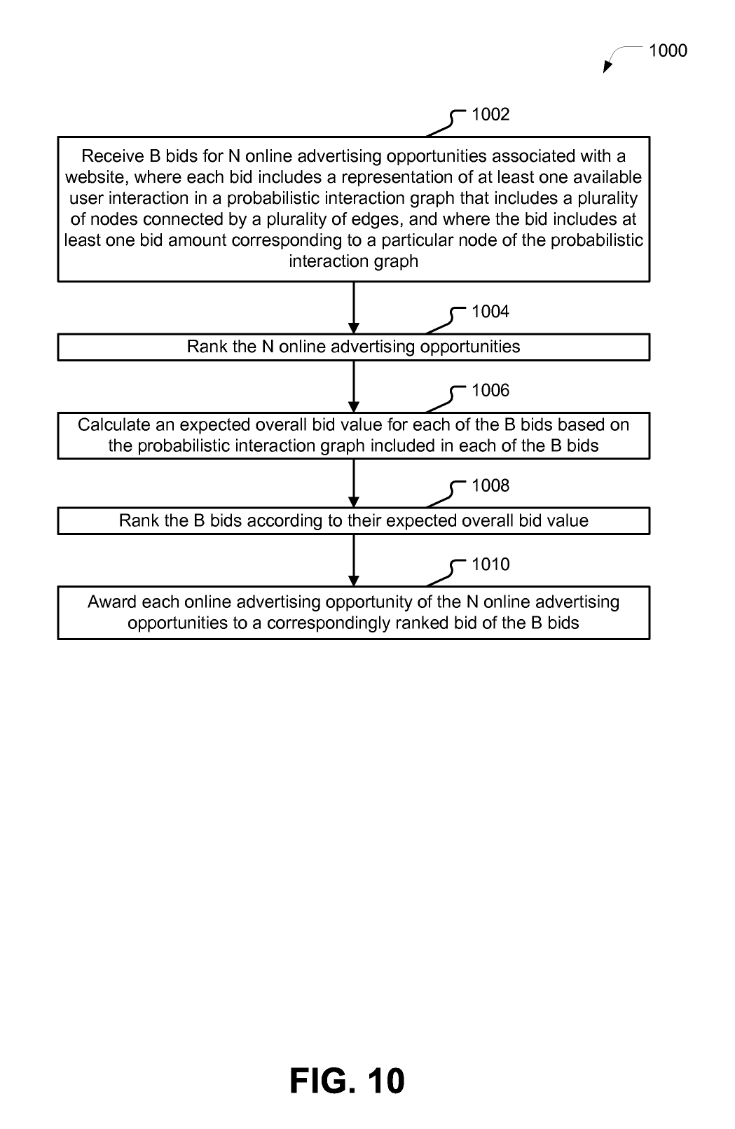

FIG. 10 is a flow diagram of a particular embodiment of a method 1000 of processing advertising bids. In an illustrative embodiment, the method may be performed by the auction system 130 of FIG. 1. The method includes receiving B bids for N online advertising opportunities associated with a website, at 1002. Each of the B bids includes a representation of at least one available user interaction at the website in a probabilistic interaction graph that includes a plurality of nodes connected by a plurality of edges. Each of the B bids also includes at least one bid amount corresponding to a particular node of the probabilistic interaction graph. For example, three bids may be received for three online advertising opportunities associated with the website, including one bid from each of the bidders 102, 104, and 106 of FIG. 1, where each of the three bids includes a probabilistic interaction graph such as one of the probabilistic interaction graphs 160 of FIG. 1, the probabilistic interaction graph 300 of FIG. 3, or the probabilistic graph 620 of FIG. 6. For example, the three opportunities may include advertising slots on the left-hand side of a webpage.

The method also includes ranking the N online advertising opportunities, at 1004. For example, the online advertising opportunities may be ranked based on a value of each of the online advertising opportunities to advertisers in general. In a particular embodiment, the value of a particular online advertising opportunity to an advertiser may be a function of a believed or measured amount of attention that users pay to the particular online advertising opportunity. For example, the three online advertising opportunities may be ranked as a highest ranked opportunity, a second ranked opportunity, and a third ranked opportunity. As an example, the highest ranked opportunity may be located at the vertically topmost slot on the left-hand side of the webpage and the lowest ranked opportunity may be the vertically bottommost slot on the left-hand side of the webpage. The method also includes calculating an expected overall bid value for each of the B bids based on the probabilistic interaction graph included in each of the B bids, at 1006. It should be noted that calculating an expected overall bid value for each of the B bids may occur independently of ranking the N online advertising opportunities and therefore may occur prior to, concurrently with, or subsequent to ranking the N online advertising opportunities. For example, the expected overall bid value calculation logic 154 of FIG. 1 may calculate an expected overall bid value for each of the 3 bids submitted by the bidders 102, 104, and 106 of FIG. 1. The method also includes ranking the B bids according to their expected overall bid value, at 1008. For example, the bid made by the bidder 104 of FIG. 1 may be ranked as a highest ranked bid, the bid made by the bidder 106 of FIG. 1 may be ranked as a second ranked bid, and the bid made by the bidder 102 of FIG. 1 may be ranked as a third ranked bid. The method also includes awarding each online advertising opportunity of the N online advertising opportunities to a corresponding ranked bid of the B bids, at 1010. For example, the highest ranked bid made by the bidder 104 may be awarded the highest ranked opportunity, the second ranked bid made by the bidder 106 may be awarded the second ranked opportunity, and the third ranked bid made by the bidder 102 may awarded the third ranked opportunity.

It will be appreciated that when not all advertising opportunities are equally attractive to advertisers, the method of FIG. 10 resolves the competition associated with the advertising opportunities on the basis of expected overall bid value. In a particular embodiment, each bidder that is awarded one of the N advertising opportunities may be charged a fee based at least partly on the expected overall bid value of the next highest ranked bid, giving bidders an incentive to submit bids that accurately reflect their true valuations of available user interactions. For example, the Vickrey-Clark-Groves (VCG) auction mechanism may be applied in conjunction with the method of FIG. 10 to incentivize truthful bidding.

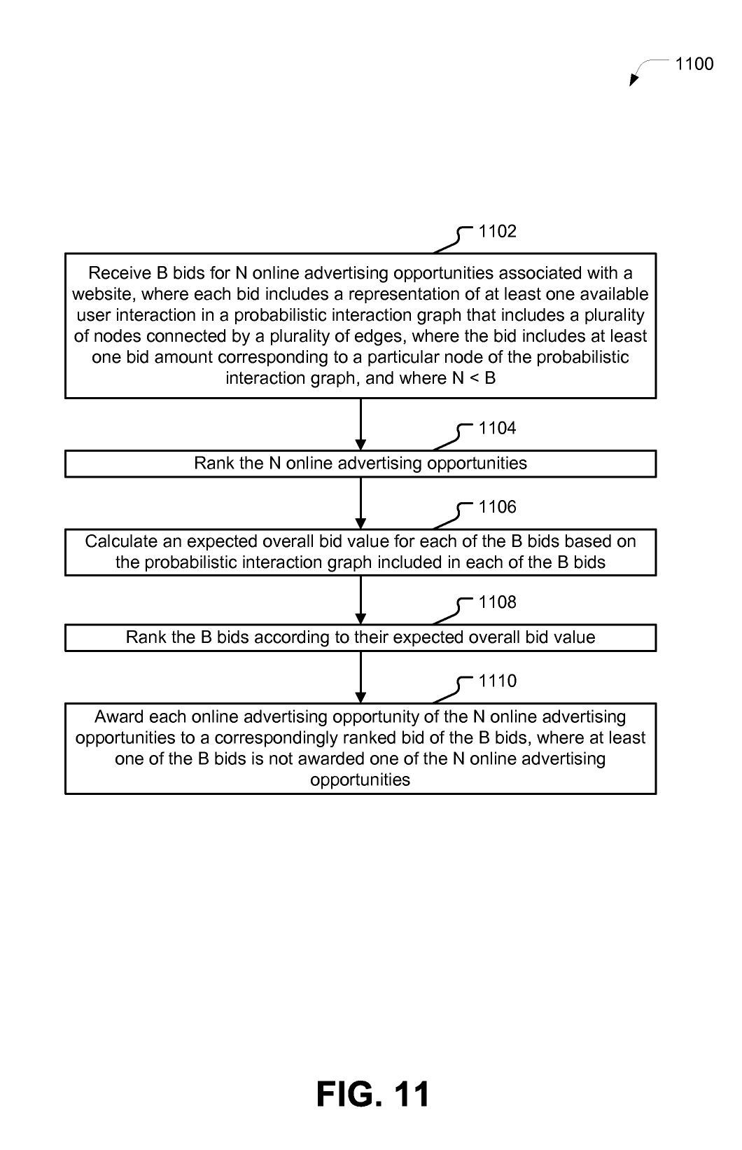

FIG. 11 is a flow diagram of another particular embodiment of a method 1100 of processing advertising bids. In an illustrative embodiment, the method may be performed by the auction system 130 of FIG. 1. The method includes receiving B bids for N online advertising opportunities associated with a website, at 1102. Each of the B bids includes a representation of at least one available user interaction at the website in a probabilistic interaction graph that includes a plurality of nodes connected by a plurality of edges. Each of the B bids also includes at least one bid amount corresponding to a particular node of the probabilistic interaction graph. Furthermore, the number of online advertising opportunities associated with the website N is less than the number of received bids B. For example, three bids may be received for two online advertising opportunities associated with the website, including one bid each from the bidders 102, 104, and 106 FIG. 1.

The method also includes ranking the N online advertising opportunities, at 1104. For example, the two online advertising opportunities may be ranked as a highest ranked opportunity and a second ranked opportunity. The method includes calculating an expected overall bid value for each of the B bids, at 1106. For example, the expected overall bid value calculation logic 154 of FIG. 1 may calculate an expected overall bid value for the three bids submitted by the bidders 102, 104, and 106 of FIG. 1. The method also includes ranking the B bids according to their expected overall bid value, at 1108. For example, the bid made by the bidder 104 of FIG. 1 may be ranked as a highest ranked bid, the bid made by the bidder 106 of FIG. 1 may be ranked as a second ranked bid, and the bid made by the bidder 102 of FIG. 1 may be ranked as a third ranked bid. The method also includes awarding each online advertising opportunity of the N online advertising opportunities to a correspondingly ranked bid of the B bids, at 1110. At least one of the B bids is not awarded one of the N online advertising opportunities. For example, the highest ranked opportunity may be awarded to the highest ranked bid made by the bidder 104 of FIG. 1, the second ranked opportunity may be awarded to the second ranked bid made by the bidder 106 of FIG. 1, and the third ranked bid made by the bidder 102 of FIG. 1 may not be awarded any of the N online advertising opportunities.

In some advertising scenarios, when the supply of advertising opportunities is less than the demand of bids, there will be competition among bidders. It will be appreciated that in those scenarios, the method of FIG. 11 resolves the competition associated with the advertising opportunities on the basis of expected overall bid value.

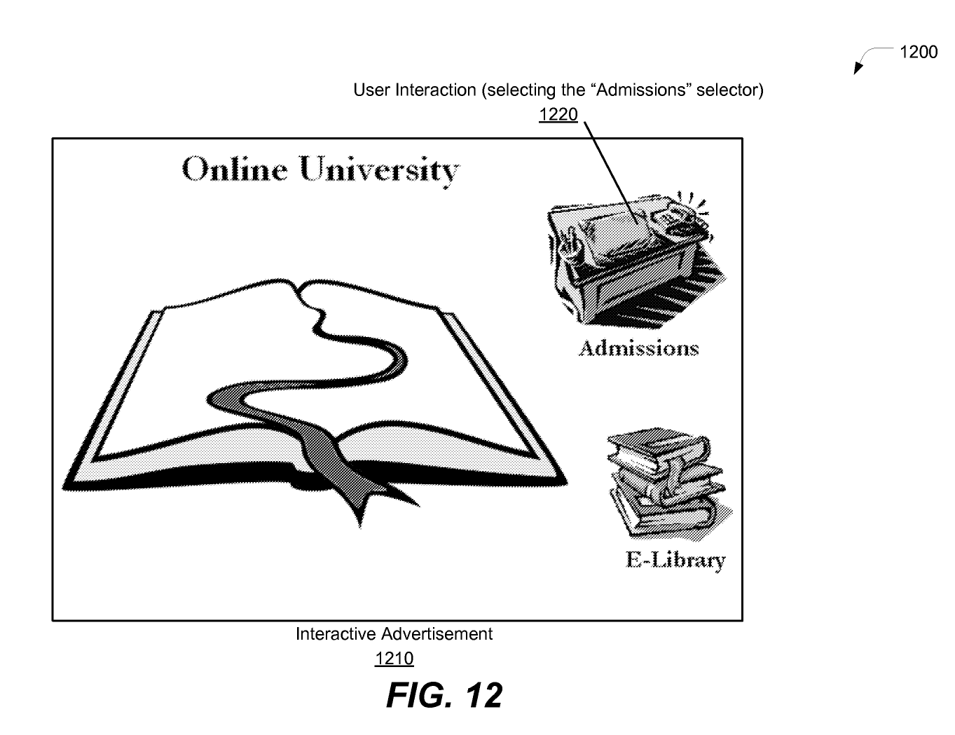

FIG. 12 is a screen shot 1200 of a particular embodiment of an interactive advertisement 1210 that may be associated with user interactions.

The interactive advertisement 1210 may include one or more selectors, i.e. user selectable regions. For example, in the particular embodiment illustrated in FIG. 12, the interactive advertisement 1210 includes an “Admissions” selector 1220.

In operation, the user interaction of selecting the “Admissions” selector 1220 in the interactive advertisement 1210 may be an available user interaction associated with the interactive advertisement 1210, and may be included in the probabilistic interaction graphs 160 of FIG. 1, the probabilistic interaction graph 300 of FIG. 3, the composite bid 610 of FIG. 6, or the probabilistic interaction graph 620 of FIG. 6.

It will be appreciated that the interactive advertisement of FIG. 12 provides a context for available user interactions that may be represented in a probabilistic interaction graph and may be bid on by bidders that submit bids for an advertising opportunity. For example, in the particular embodiment illustrated in FIG. 12, the interactive advertisement is for Online University (OU). When OU becomes aware of an available advertising slot at a website, OU may wish to bid on the advertising slot, intending to insert the interactive advertisement 1210 into the available advertising slot if they win the auction. In addition to bidding on currently available user interactions at the website, OU may also include bid amounts in their bid that correspond to user interactions that are particular to the interactive advertisement 1210, such as the user interaction of selecting the “Admissions” selector 1220.

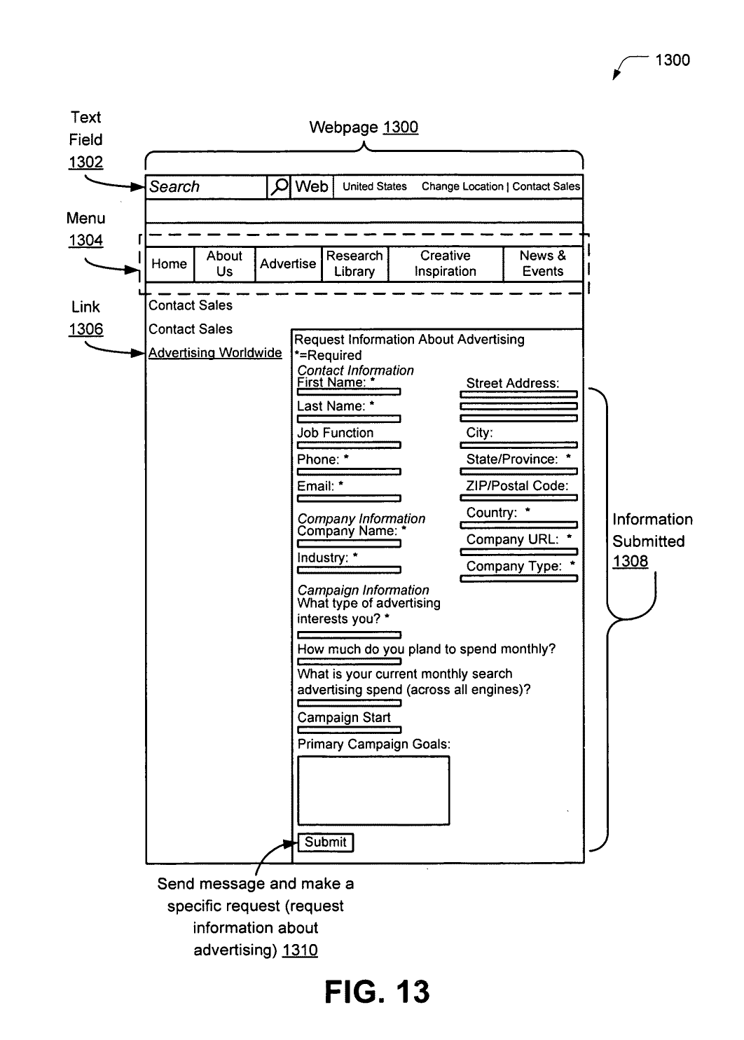

FIG. 13 is a screenshot of a particular embodiment of webpage 1300 that may be associated with user interactions.

The webpage may include one or more elements. For example, in the particular embodiment illustrated in FIG. 13, the webpage 1300 includes a text field 1302, a menu 1304, a link 1306, a section to collect information submitted 1308 by a visitor to the webpage, and a button to send a message and make a specific request 1310.

In operation, the elements of the webpage 1300 may correspond to available user interactions associated with the webpage 1300 and may be included in the probabilistic interaction graphs 160 of FIG. 1, the probabilistic interaction graph 300 of FIG. 3, the composite bid 610 of FIG. 6, or the probabilistic interaction graph 620 of FIG. 6. For example, viewing the webpage 1300, entering text into the text field 1302, clicking on one of the selections provided by the menu 1304, clicking on the link 1306, submitting information via the section to collect information submitted by visitors 1308, and clicking on the “Submit” button to send a message and make a specific request 1310 may each be available user interactions subject to bidding. In the particular embodiment illustrated in FIG. 13, clicking on the “Submit” button sends a request for information about advertising at the website associated with the webpage 1300.

It will be appreciated that the webpage 1300 of FIG. 13 provides yet another context for available user interactions that may be represented in a probabilistic interaction graph and may be bid on by bidders that are submitting bids for an advertising opportunity.

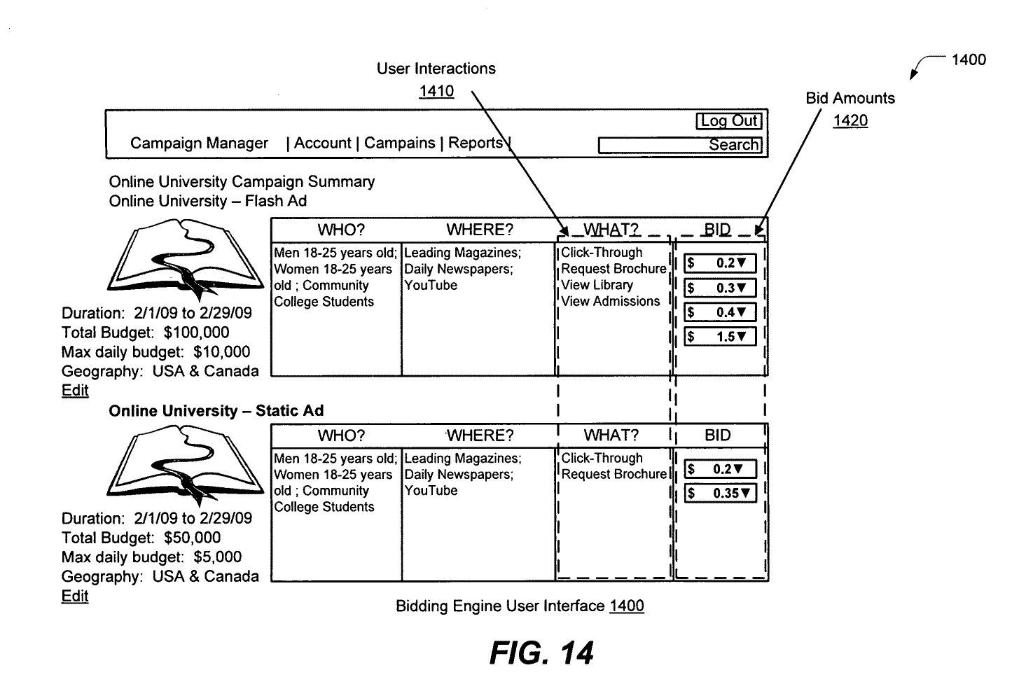

FIG. 14 is a screenshot of a particular embodiment of a bidding engine user interface 1400 that may be used to submit advertising bids based on user interactions. In an illustrative embodiment, the bidding engine user interface 1400 may be generated by the user interface generation logic 142 of FIG. 1 and may be displayed to the bidders 102, 104, and 106 of FIG. 1.

The bidding engine user interface 1400 may include a section to enter user interactions 1410 and a section to enter bid amounts 1420 associated with the entered user interactions 1410.

In operation, a bidder may use the bidding engine user interface 1400 to enter bid amounts for available user interactions. For example, in the particular embodiment illustrated in FIG. 14, a bidder has entered the user interactions 1410 of Click Through, Request Brochure, View Library, and View Admissions. Furthermore, in the particular embodiment illustrated in FIG. 14, a bidder has entered the bid amounts 1420 including a bid amount of $0.20 corresponding to the user interaction of Clicking Through, a bid amount of $0.30 corresponding to the user interaction of Requesting a Brochure, a bid amount of $0.40 corresponding to the user interaction of Viewing Library, and a bid amount of $1.50 corresponding to the user interaction of Viewing Admissions. It will be noted that in the particular embodiment illustrated in FIG. 14, the bidder is entering a composite bid, similar to the composite bid 610 of FIG. 6, that will be mapped by a mapping process similar to the mapping process 640 of FIG. 6, to generate an associated probabilistic interaction graph.

It will be appreciated that the bidding engine user interface 1400 of FIG. 14 provides bidders with an interface to submit bids by selecting available user interactions and entering bid amounts for the selected available user interactions. It will also be appreciated that the bidding engine user interface 1400 simplifies the bidding process by not requiring bidders to identify the relationship between the various selected available user interactions. It will further be appreciated that the selected available user interactions may be mapped to a probabilistic interaction graph, as described with reference to FIG. 6. For example, in reference to the interactive advertisement 1210 of FIG. 12, the impression of the interactive advertisement 1210 may correspond to a root node of the probabilistic interaction graph, and the user interactions of clicking on the “Admissions” selector and clicking on the “E-Library” selector may correspond to leaf nodes of the probabilistic interaction graph that are attached to the root node.

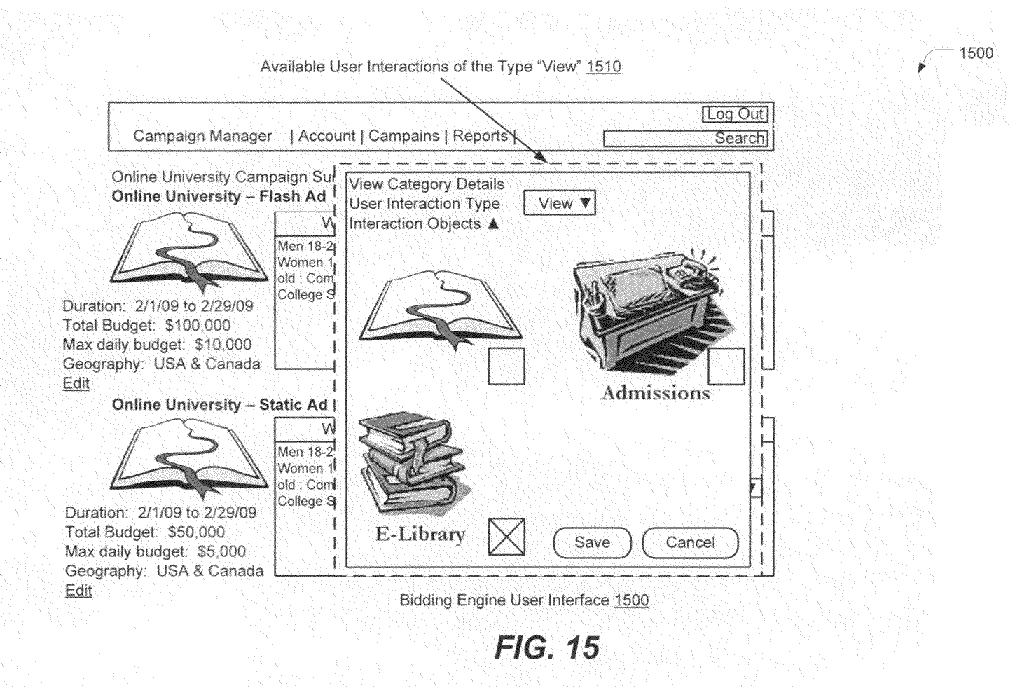

FIG. 15 is a screenshot of another particular embodiment of a bidding engine user interface 1500 that may be used to submit advertising bids based on user interactions. In an illustrative embodiment, the bidding engine user interface 1500 may be generated by the user interface generation logic 142 of FIG. 1 and may be displayed to the bidders 102, 104, and 106 of FIG. 1.

The bidding engine user interface 1500 may include an option to view and select available user interactions on the basis of user interaction type. In an illustrative embodiment, the user interaction type may include a user interaction type 630 of FIG. 6.

In operation, a bidder may use the bidding engine user interface 1500 to view and select available user interactions on the basis of user interaction type. For example, in the particular embodiment illustrated in FIG. 15, a bidder may use the bidding engine user interface 1500 to see the available user interactions of the type “View” 1510 and to select some of them.

It will be appreciated that the bidding engine user interface 1500 of FIG. 15 may make the bidding process easier by enabling bidders to group available user interactions by user interaction type. This option provides a more organized bidding experience when there are many user interaction types and many available user interactions for each user interaction type. For example, available user interaction types may include view (corresponding to viewing information within an advertisement), click-through (corresponding to clicking through to the advertiser's website), and webpage view (corresponding to viewing webpages within the website).

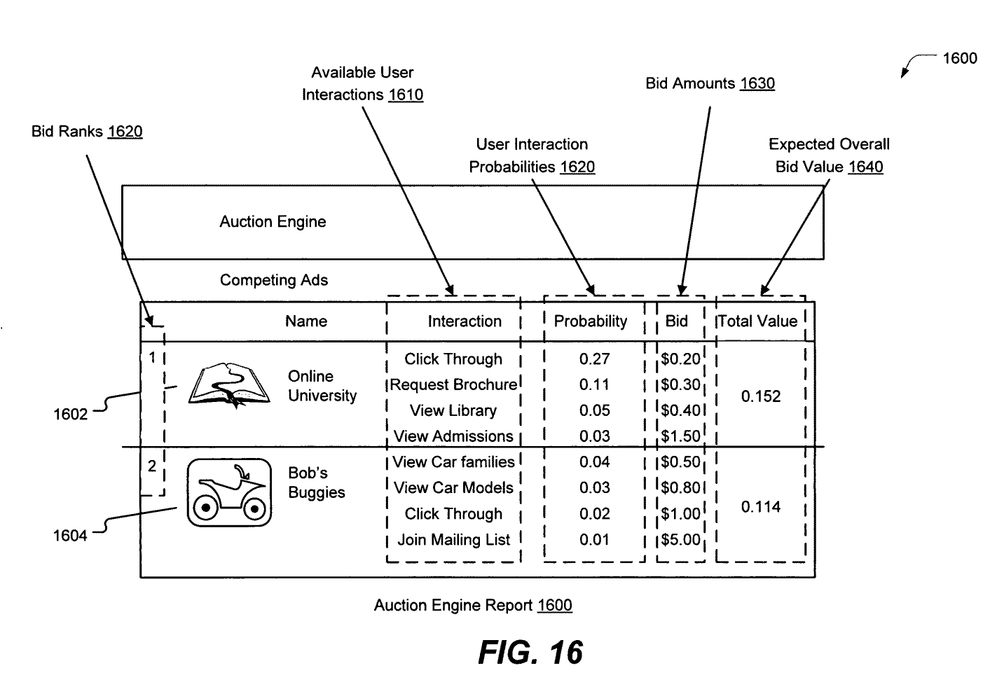

FIG. 16 is a screenshot of a particular embodiment of an auction engine report 1600 that may indicate the result of evaluating advertising bids based on user interactions. In an illustrative embodiment, the auction engine report 1600 may indicate the result of evaluating bids from the bidders 102, 104, and 106 of FIG. 1 by the auction engine 150 of FIG. 1.

The auction engine report 1600 may be produced in real-time, or near real-time, as part of a monitoring console or offline through a reporting system. The auction engine report 1600 may include, for each submitted bid, the available user interactions 1610 included in that submitted bid, the user interaction probabilities 1620 associated with the available user interactions, the bid amounts 1630 for the available user interactions 1610, and an expected overall bid value 1640 for that submitted bid. The auction engine report 1600 may also rank each submitted bid on the basis of expected overall bid value, and assign bid ranks 1650 to the submitted bids. In an illustrative embodiment, the available user interaction probabilities may be determined by the user interaction probability determination logic 170 of FIG. 1, the expected overall bid value 1640 may be calculated by the expected overall bid value calculation logic 154 of FIG. 1, and the bid ranks 1650 may be determined and assigned by the winning bid selection logic 156 of FIG. 1.

In the particular embodiment illustrated in FIG. 16, the Online University bid 1602 is ranked higher than the Bob's Buggies bid 1604, because the Online University bid 1602 has an expected overall bid value of 0.152, which is higher than 0.114, the expected overall bid value of the Bob's Buggies bid 1604.

It will be appreciated that the auction engine report 1600 provides the owners of auction systems with a single accounting of the bids, user interactions, probabilities, bid amounts, and expected overall bid values involved in a particular advertising auction.

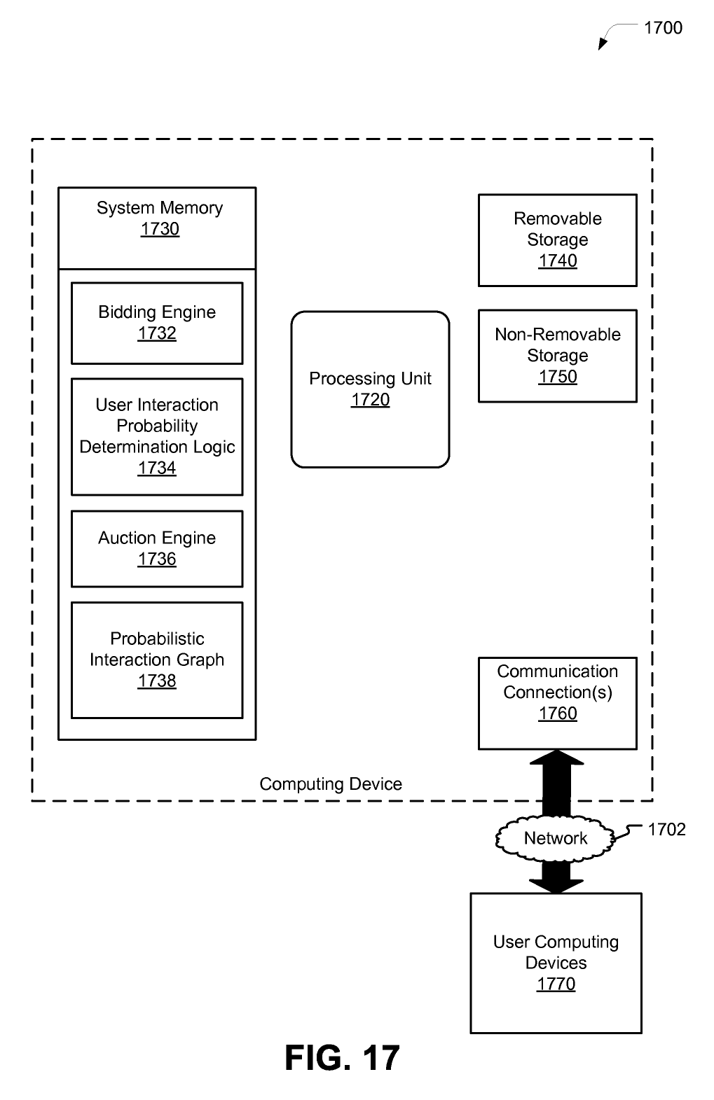

FIG. 17 shows a block diagram of a computing environment 1700 including a computing device 710 operable to support embodiments of computer-implemented methods, computer program products, system components, apparatus, and articles of manufacture including programming logic according to the present disclosure. In a basic configuration, the computing device 1710 may include an auction system configured as described with reference to FIGS. 1-16. For example, the computing device 1710 may include the auction system 130 of FIG. 1.

The computing device 1710 typically includes at least one processing unit 1720 and system memory 1730. Depending on the exact configuration and type of computing device, the system memory 1730 may be volatile (such as random access memory or “RAM”), non-volatile (such as read-only memory or “ROM,” flash memory, and similar memory devices that maintain the data they store even when power is not provided to them) or some combination of the two. In a basic configuration, the system memory 1730 includes a bidding engine 1732, user interaction probability determination logic 1734, an auction engine 1736, and the probabilistic interaction graphs 1738. For example, the bidding engine 1732 may include the bidding engine 140 of FIG. 1, the user interaction probability determination logic 1734 may include the user interaction probability determination logic 170 of FIG. 1, the auction engine 1736 may include the auction engine 150 of FIG. 1, and the probabilistic interaction graph 1738 may include one of the probabilistic interaction graphs 160 of FIG. 1, the probabilistic interaction graph 300 of FIG. 3, or the probabilistic interaction graph 620 of FIG. 6. In a particular embodiment, the system memory 1730 also includes logic to generate, update, and modify the probabilistic interaction graph 1738.

The computing device 1710 may also have additional features or functionality. For example, the computing device 1710 may also include removable and/or non-removable additional data storage devices such as magnetic disks, optical disks, tape, and standard-sized or miniature flash memory cards. Such additional storage is illustrated in FIG. 17 by removable storage 1740 and non-removable storage 1750. Computer storage media may include volatile and/or non-volatile storage and removable and/or non-removable media implemented in any method or technology for storage of information such as computer-readable instructions, data structures, program components or other data. The system memory 1730, the removable storage 1740 and the non-removable storage 1750 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium which can be used to store the desired information and which can be accessed by computing device 1710. Any such computer storage media may be part of the device 1710.

The computing device 1710 also contains one or more communication connections 1760 that allow the computing device 1710 to communicate with other computing devices 1770, such as one or more client user computing systems or other servers, over a wired or a wireless network. In a particular embodiment, the computing device 1710 may communicate with the user computing devices 112, 114, and 116 of FIG. 1 via the network 1702 that may include the network 120 of FIG. 1. The one or more communication connections 1760 are an example of communication media. By way of example, and not limitation, communication media may include wired media such as a wired network or direct-wired connection, and wireless media such as acoustic, RF, infrared and other wireless media. It will be appreciated, however, that not all of the components or devices illustrated in FIG. 17 or otherwise described in the previous paragraphs are necessary to support embodiments as herein described.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
representing a plurality of available user interactions in a probabilistic interaction graph, wherein the probabilistic interaction graph comprises a plurality of nodes connected by a plurality of edges, each node of the plurality of nodes representing a particular available user interaction and each edge of the plurality of edges having an associated user interaction probability;
at a computer, receiving a plurality of bids from a plurality of bidders for an advertising opportunity, wherein each bid of the plurality of bids includes at least one bid amount corresponding to an available user interaction;
calculating an expected overall bid value for each of the plurality of bids at the computer;
choosing a winning bid from the plurality of bids on the basis of a highest expected overall bid value;
awarding the advertising opportunity to a winning bidder associated with the winning bid; and
charging the winning bidder a fee based on actual user interactions, the highest expected overall bid value of the winning bid, and a second highest expected overall bid value of a second place bid.

2. The method of claim 1, wherein the user interaction probabilities are determined predictively.

3. The method of claim 1, wherein the user interaction probabilities are determined from empirical data by tracking user activity and further comprising updating the user interaction probabilities based on the tracked user activity.

4. The method of claim 3, wherein the user interaction probability associated with a particular edge between a child node and a parent node is based on a ratio of a first number of users that perform a child user interaction corresponding to the child node to a second number of users that perform a parent user interaction corresponding to the parent node.

5. The method of claim 1, wherein at least one of the plurality of available user interactions is a user interaction capable of being performed by at least one of a website, a game, a computer application, and a mobile device.

6. The method of claim 1, wherein the plurality of available user interactions includes at least one of: interacting with an interactive advertisement, viewing a particular webpage, selecting an option from a menu, clicking on a selector, clicking on a link, typing in a text field, making a specific request, sending a message, and submitting information.

7. The method of claim 1, wherein calculating the expected overall bid value from a particular bid of the plurality of bids comprises:
using the probabilistic interaction graph to calculate an expected bid amount value for each bid amount of the particular bid by taking a product of each bid amount and the user interaction probability associated with the user interaction corresponding to each bid amount to produce an expected bid amount value for each bid amount; and
calculating the expected overall bid value as a sum of each of the expected bid amount values.

8. The method of claim 1, wherein the fee is further based on a sum of bid amounts associated with the performance of user interactions represented by edges of the probabilistic interaction graph, a maximum bid amount associated with the performance of user interactions represented by edges of the probabilistic interaction graph, or any combination thereof.

9. The method of claim 1, wherein at least one bid of the plurality of bids is a composite bid comprising a first bid amount corresponding to a first available user interaction of a first user interaction type and a second bid amount corresponding to a second available user interaction of a second user interaction type that is different from the first user interaction type.

10. A system comprising:
a bidding engine to:
access a probabilistic interaction graph representing a plurality of available user interactions, wherein the probabilistic interaction graph comprises a plurality of nodes and a plurality of edges, each node corresponding to an available user interaction of the plurality of available user interactions and each edge of the plurality of edges having an associated user interaction probability; and
provide a user interface that allows a bidder to:
enter at least one bid amount corresponding to each available user interaction; and
submit a bid, wherein the bid comprises the at least one bid amount; and
an auction engine to:
receive a plurality of bids submitted by a plurality of bidders via the bidding engine;
calculate an expected overall bid value for each of the plurality of bids; and
choose a winning bid from the plurality of bids on the basis of a highest expected overall bid value.

11. The system of claim 10, further comprising logic to determine the user interaction probability associated with each edge.

12. The system of claim 10, wherein the bid is a composite bid comprising a first bid amount corresponding to a first available user interaction of a first user interaction type and a second bid amount corresponding to a second available user interaction of a second user interaction type that is different from the first user interaction type.

13. The system of claim 12, wherein the auction engine calculates the expected overall bid value for the composite bid by:
for each bid amount of the composite bid, calculating an expected bid amount value equal to a product of the bid amount and the user interaction probability associated with the available user interaction corresponding to the bid amount; and
calculating the expected overall bid value of the composite bid as the sum of each of the expected bid amount values.

14. The system of claim 13, wherein the auction engine accesses the probabilistic interaction graph to determine the user interaction probability associated with the available user interaction corresponding to each bid amount of the composite bid.

15. The system of claim 10, wherein the user interface includes an option to allow the bidder to enter a set of bid amounts and user interactions without defining the relationship between any of the user interactions, and wherein the bidding engine maps the set of bid amounts and user interactions to the probabilistic interaction graph.

16. The system of claim 10, wherein the user interface:
detects an entered bid amount corresponding to a particular node; and
notifies the bidder that bids are not required for available user interactions corresponding to child nodes of the particular node.

17. The system of claim 10, wherein the user interface does not allow the bidder to enter a bid amount corresponding to a node connected to an edge whose user interaction probability is below a minimum probability threshold.

18. The system of claim 10, wherein the user interface includes an option to add a new child node to an existing node and an option to add a new directed edge between a first existing node and a second existing node.

19. A computer-readable medium comprising instructions, that when executed by a computer, cause the computer to:
receive B bids for N online advertising opportunities associated with the website, wherein each bid includes a representation of at least one available user interaction at the website in a probabilistic interaction graph, the probabilistic interaction graph comprising a plurality of nodes connected by a plurality of edges, each bid further including at least one bid amount corresponding to a particular node of the probabilistic interaction graph;
rank the N online advertising opportunities;
calculate an expected overall bid value for each of the B bids based on the probabilistic interaction graph included in each of the B bids;
rank the B bids according to their expected overall bid value; and
award each online advertising opportunity of the N advertising opportunities to a correspondingly ranked bid of the B bids.

20. The computer-readable medium of claim 18, wherein the number of online advertising opportunities N is less than the number of received bids B, and wherein at least one of the B bids is not awarded any of the N online advertising opportunities.
